(19) United States
(12) Patent Application Publication
(10) Pub. No.: US 2005/0194463 A1
(43) Pub. Date: Sep. 8, 2005

(54) Fuel injector with variable control chamber pressurization

(76) Inventor: Friedrich Boecking, Stuttgart (DE)

Correspondence Address: Ronald E Greigg;Greigg & Greigg, Suite One, 1423 Powhattan Street, Alexandria, VA, 22314, US

(21) Appl. No.: 10/482,027

(22) PCT Filed: Jun. 19, 2002
(86) PCT No.: PCT/DE02/02235

§ 371 Date: Jun. 28, 2004

(30) Foreign Application Priority Data
Jun. 29, 2001 (DE) 1 01 31 642.9

(51) Int. Cl. F02M 61/06

(52) U.S. Cl. 239/96; 239/533.4

(57) ABSTRACT

A fuel injector for an internal combustion engine, with a control chamber contained in an injector housing and acted on with highly pressurized fuel via a permanently acting inlet throttle in an inlet from a high-pressure accumulator. A nozzle needle/tappet device protrudes into this control chamber and is actuated in a movement directed (10) by the pressure decrease or pressure increase in the control chamber a pressure relief in the control chamber being produced by means of a multi-way valve activated by an actuator. The valve chamber of the multi-way valve and the control chamber in the injector housing are connected to each other by means of two conduits, one of which is closed when the multi-way valve is in a second switched position and is open when the multi-way valve is in a middle position.

### TECHNICAL FIELD

In modern air-compressing internal combustion engines, increasing use is being made of accumulator injection systems, which supply highly pressurized fuel to the individual fuel injectors associated with the cylinders of the engine. Through the use of a high-pressure accumulator (common rail), it is possible to damp pressure pulsations in the fuel so that the fuel pressure in the individual injection openings of the fuel injectors oriented toward the combustion chamber can be kept virtually constant. In order to control the nozzle needle movement, control chambers are integrated into the housing of the fuel injectors and when the pressure in these control chambers is relieved, a nozzle needle or a tappet for indirect nozzle needle actuation, can be actuated in order to open or close injection openings. In general, a volume of highly pressurized fuel from the high-pressure source can act on the control chamber via an inlet throttle.

### PRIOR ART

EP 0 994 248 A2 relates to a fuel injector with a shaping of the discharge rate curve through piezoelectric control of the nozzle needle stroke. A fuel injector includes a cylindrical body in which an injection opening is provided. A nozzle needle is contained so that it can move in the injector body and moves along a stroke path between an open position in which the injection openings are open and a closed position in which the injection openings are closed. The injector body also contains a piezoelectric actuator whose piezoelectric element can be switched back and forth between an ON position and an OFF position. A coupling element in the form of a pressure chamber couples the nozzle needle and the piezoelectric actuator to each other in such a way that the movement of the piezoelectric element of the piezoelectric actuator is converted into a greater axial stroke motion of the nozzle needle in the injector housing.

DE 197 15 234 A1 relates to a solenoid valve-controlled, direct-injection fuel injection valve for accumulator injection systems of multi-cylinder internal combustion engines. In each valve housing, a supply line leads to a spring-loaded nozzle needle; the supply line can be closed by means of a control piston that functions as a valve. A nozzle needle is also provided, which is supported in a spring chamber and presses the nozzle needle against its needle seat. The control piston that is subjected to the system pressure has a control chamber at its rear end; a solenoid valve is provided, which can connect the control chamber to a relief line and at the same time as the injection, the closing of the supply line leading to the nozzle needle can be offset by a high-pressure valve disposed on the control piston. A throttled line connection is provided as a bypass between the supply line and the relief line; the line connection contains a leakage valve that is operationally connected to the solenoid valve and can disconnect the line connection during the injection.

DE 197 44 518 A1 relates to a fuel injection valve for internal combustion engines. It proposes a fuel injection valve with an axially movable valve element, which is contained in a valve body and whose end oriented toward the combustion chamber of the internal combustion engine has a conical valve sealing surface that cooperates with a conical valve seat surface on the valve body in order to control an injection cross section. The valve element is guided via an internal guide so that it can slide smoothly on a pin of a stationary insert body. The fuel injection valve for internal combustion engines that is configured according to this disclosure has the advantage of permitting very small adjusting forces and consequently very rapid adjusting movements of the valve element of the injection valve. These rapid adjusting movements inside the injector housing are possible due to the small hydraulically effective areas on the valve element and the small control volume; only small moving masses have to be adjusted. This is achieved in particular by virtue of the fact that the valve element has a guide bore that allows it to be guided in a smoothly sliding fashion on a pin of a stationary insert body.

### DESCRIPTION OF THE INVENTION

The advantages of the embodiment according to the invention lie primarily in that the valve chamber of a multi-way valve and the pressure increase and pressure decrease in a control chamber, which generate the opening and closing movement of a nozzle needle/tappet device, are connected to each other via at least one conduits that the control volume can flow through in the inlet direction and the outlet direction in relation to the control chamber.

In a first embodiment, a 3/3-way valve is used as the multi-way valve, whose valve body is enclosed by a valve chamber into which the mouth of an additional inlet from the high-pressure accumulator feeds. An actuator (e.g. a piezoelectric actuator) can switch the valve body of the multi-way valve between two valve seats in the valve chamber and can also place it in a middle position between these two valve seats.

In the middle position of the valve body between the first and the second valve seat in the valve chamber, the pressure in the control chamber is rapidly relieved via the throttle elements that are contained in the conduits and are provided with sufficiently large cross sections. However, if the actuator causes the valve body to move into its second valve seat, one of the conduits between the valve chamber and the control chamber is closed so that the pressure decrease in the control chamber occurs more slowly, which facilitates the shaping of the discharge rate curve. But if the valve body of the 3/3-way valve is moved into its first valve seat, a pressure increase occurs in the control chamber via a permanently active inlet throttle feeding directly into the control chamber and the two conduits leading from the valve chamber to the control chamber, which are acted on via the additional inlet with the integrated inlet throttle feeding into the angled chamber, thus causing a more rapid pressure buildup in the control chamber.

The additional high-pressure inlet from the high-pressure accumulator (common rail) can also feed into one of the conduits that connect to the valve chamber of the multi-way valve, downstream of the control chamber.

In another embodiment, the additional inlet from the high-pressure accumulator can feed into the one of the conduits that can be closed by the valve body of the multi-way valve. Between the opening of the additional inlet into this conduit and the throttle element contained in this conduit, a diffuser section is provided, whose length is determined so that the fuel flow occurring in this conduit can come into contact with the wall of the conduit.

This embodiment also assures a more rapid pressure increase in the control chamber and therefore a rapid closing of the nozzle needle or a rapid actuation of the nozzle needle by means of a tappet protruding into the nozzle chamber. Depending on the design of the throttle element disposed in the additional inlet, very small injection quantities can be produced during the boot phase of the injection into the combustion chamber, which makes it possible to match the discharge rate curve to the progress of the combustion in the combustion chamber of a direct-injecting internal combustion engine.

### DRAWINGS

The invention will be explained in detail below in conjunction with the drawings.

FIG. 1 shows an embodiment of a variable control chamber pressurization and pressure relief with a 3/3-way valve,

FIG. 2 shows an embodiment with a 3/2-way valve and an additional inlet from the high-pressure accumulator feeding into one of the conduits,

FIG. 3 shows an injector body with an inlet throttle element that can be acted on in parallel by means of a high-pressure-side inlet, and

FIG. 4 shows another embodiment with only one flow conduit leading from the valve chamber to the control chamber.

### EXEMPLARY EMBODIMENTS

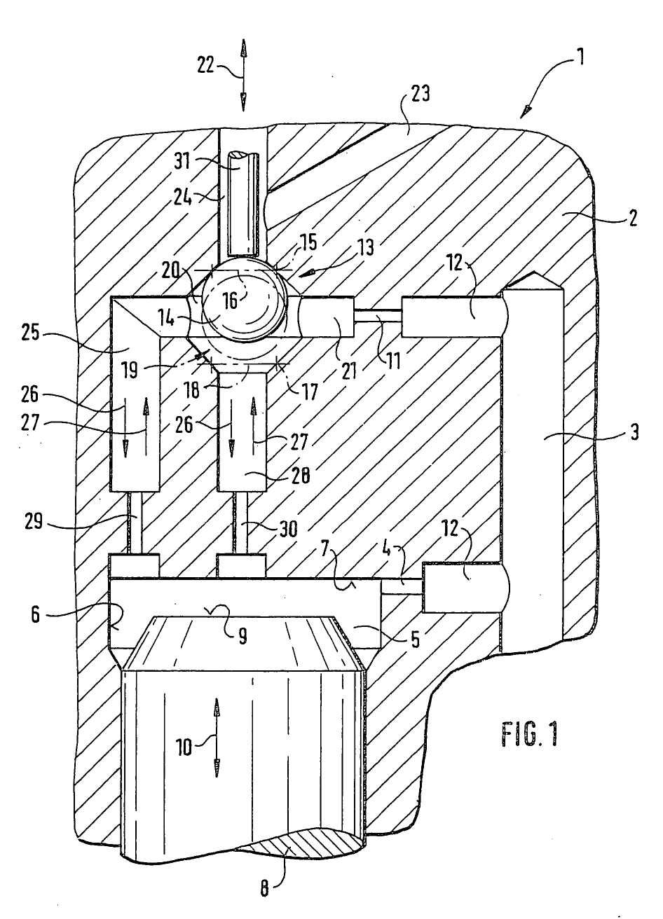

According to the depiction in FIG. 1, the control chamber of a fuel injector is pressurized or pressure-relieved by means of a multi-way valve, which is embodied here in the form of a 3/3-way valve.

An injector housing 2 of an injector 1 contains a control chamber 5, which is acted on with highly pressurized fuel by means of a permanently active first inlet throttle 4 that is connected to a bore 12 that branches from the high-pressure accumulator along with the inlet. The control chamber 5 inside the injector housing 2 is delimited laterally by a control chamber wall 6 and at the top by a control chamber surface 7. A nozzle needle/tappet device 8 plunges into the control chamber 5 with its end surface 9, which can be moved in one of the movement directions indicated by the double arrow 10 depending on whether the pressure in the control chamber 5 decreases or increases.

In addition, the inlet 3 from the high-pressure accumulator, also via a bore 12, acts on an additional inlet 21 with an integrated second inlet throttle element 11, which additional inlet 21 feeds into the valve chamber 20 of a multi-way valve 13. The multi-way valve 13—embodied as a 3/3-way valve in the depiction according to FIG. 1—includes a valve closing body 14 that a transmission element labeled with the reference numeral 31 can move into a number of positions inside the valve chamber 20, depending on how an actuator 22 is controlled. The valve body 14 of the multi-way valve 13 can be moved into a first valve seat 15, whose valve seat diameter is labeled with the reference numeral 16; the valve body 14, which can be embodied as spherical for example, can also be moved into a second valve seat 17, which is embodied with the valve seat diameter 18 and is disposed opposite from the first valve seat 15 in the valve chamber 20. In addition, the valve body 14 of the multi-way valve 13 can be moved into a middle position 19 between the first valve seat 15 and the second valve seat 17 inside the valve chamber 20.

Above the valve chamber 20 of the multi-way valve 13, a bore is provided, through which the transmission element 31 that actuates the valve body 14 extends. This produces an annular gap 24 between the circumference surface of the transmission element 31 and the wall of the injector housing 2 delimiting the bore, and an outlet (23) branches off from this annular gap 24.

The valve chamber 20 of the multi-way valve 13 is connected to the control chamber 5 of the injector housing 2 via two conduits that are disposed parallel to each other in the depiction according to FIG. 1, i.e. the first conduit 25 and the second conduit 28. The first conduit 25 and the second conduit 28 are each provided with a respective throttle element 29 and 30. Control volumes flowing out of the control chamber 5 and highly pressurized fuel volumes traveling in the inlet direction 26 via the additional inlet 21 and the valve chamber 20 can flow through the two conduits 25 and 28, both in the inlet direction 26 in relation to the control chamber 5 and in the outlet direction 27 in relation to the control chamber 5. The opening of the first conduit 25 is designed so that it feeds into the valve chamber 20 next to the valve body 14 of the multi-way valve 13, while the second conduit 28 feeds into the valve chamber 20 of the multi-way valve 13 underneath the second valve seat 17 with the valve seat diameter.

According to the depiction in FIG. 1, the control chamber 5 is constantly connected to the inlet part of the high-pressure accumulator via the permanently active first inlet throttle 4. When the valve body 14 of the multi-way valve 13 is positioned in the first valve seat 15, high pressure prevails in the control chamber 5. With the valve body 14 placed in the valve seat diameter 16, the valve chamber 20 of the multi-way valve 13 is sealed off from the outlet 23. If the actuator 22 opens the valve body of the multi-way valve 13 and places it in a middle position 19 (depicted with dashed lines), then the pressure in the control chamber 5 is relieved in the outlet direction 27 via the permanently open first conduit 25 and the throttle element 29 contained in it, and via the second conduit 28 that is opened in the middle position 19. Through suitable design of the throttle cross sections of the throttle element 29 in the first conduit 25 and of the additional throttle element 30 in the second conduit 28, the pressure in the control chamber 5 can be decreased very rapidly. This makes it possible to achieve a rapid opening of the nozzle needle/tappet device 8. If the valve body 14 of the multi-way valve 13, however, is moved from its middle position 19 into the sealed position in its second seat 17, then the second conduit 28 is closed. In this switched position of the valve body 14 of the multi-way valve 13, a pressure decrease in the control chamber 5 can occur only via the permanently active first control conduit 25 into the valve chamber 20 of the multi-way valve 13. In this case, the pressure in the control chamber 5 decreases more slowly as compared with a pressure decrease in the control chamber 5 that can occur via the two parallel conduits 25 and 28 when the valve body 14 of the multi-way valve 13 has been moved into the middle position 19.

If the valve body 14, through actuation of the actuator 22, is moved into the first valve seat 15, then the pressure increase in the control chamber 5 of the injector housing also occurs via the additional inlet 21 feeding into the valve chamber 20 from the inlet 3 of the high-pressure accumulator. In this case, highly pressurized fuel flows through the inlets to the first conduit 25 and the second conduit 28 in the inlet direction 26 in relation to the control chamber 5, and fuel volumes travel backward into the control chamber 5 through both of the throttle elements 29 and 30, which in this case act as inlet throttles. This produces a rapid pressure increase in the control chamber 5, causing a rapid closing of the nozzle needle/tappet device 8 into its closing seat, which is not shown in FIG. 1.

With this fuel injector, which can be operated as a servo valve-injector, it is possible to achieve a shaping of the discharge rate curve with a simultaneously rapid closing of the needle since the 3/3-way valve 13 makes it possible to open one or both flow conduits 25 and 28, thus producing different pressure change speeds in the nozzle chamber 5 in the injector housing 2 of the fuel injector 1.

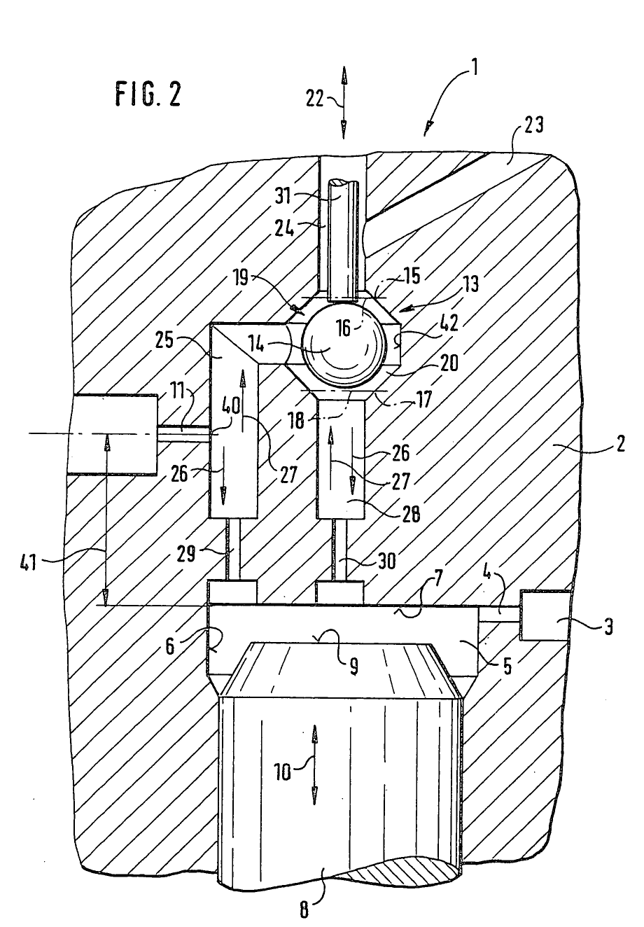

FIG. 2 gives a detailed depiction of an embodiment with a 3/2-way valve and an additional inlet from the high-pressure accumulator that feeds into one of the flow conduits.

Analogous to the depiction in FIG. 1, the control chamber 5 in the injector housing 2 is connected to the valve chamber 20 of a multi-way valve 13 via two parallel conduits, namely a first conduit 25 and a second conduit 28. The valve chamber 20 of the multi-way valve 13 contains a preferably spherical valve body 14 that an actuator element 22 with a transmission element 31 can move into a first valve seat 15, a middle position 19, and a lower valve seat 17. The two conduits 25 and 28 connecting the valve chamber 20 of the multi-way valve 13 to the control chamber 5 permit the passage of control volumes flowing both in the inlet direction 26 and the outlet direction 27 in relation to the control chamber 5 and permit the passage of incoming fuel volumes.

By contrast to the depiction in FIG. 1, the additional inlet 11 feeds from the high-pressure accumulator into the first conduit 25 spaced a distance 41 apart from the delimiting surface 7 of the control chamber 5 in the injector housing 2.

If the valve body 14 of the multi-way valve 13 is placed in its first seat 15, then the outlet 23 is closed and a pressure increase occurs in the control chamber 5 via the permanently active first inlet throttle 4 and the additional inlet 11 from the high-pressure accumulator feeding into the first flow conduit 25. In this embodiment, the permanently active inlet throttle 4 and the additional inlet 11 from the high-pressure accumulator act permanently on the control chamber 5. The throttle elements 29 and 30 in the first conduit 25 and the second conduit 28, whose throttle cross sections are relatively large in comparison to the permanently active inlet throttles 4 and 11, produce a rapid pressure decrease in the control chamber 5 into the valve chamber 20 when the valve body 14 of the multi-way valve 13 is placed in its middle position 19 as shown in FIG. 2.

By means of the embodiments shown in FIGS. 1 and 2, the pressure decrease in the control chamber 5, which is associated with at least one permanently active inlet throttle 4, can occur either via a first conduit 25 at a first pressure decrease speed when the valve body 14 of the multi-way valve 13 is placed in its second seat 17. When the valve body 14 of the multi-way valve 13 is placed in its middle position 19, the first conduit 25 is connected in parallel with the second conduit 28 so that the pressure decrease in the control chamber 5 can occur by means of two parallel conduits into the valve chamber 20 and from there, the pressure can be relieved into the outlet 23. The throttle elements 29 and 30 contained in the first conduit 25 and the second conduit 28 are designed with a larger cross section so that a large flow occurs through the throttle elements 29 and 30 and therefore a rapid pressure decrease. The pressure decrease speeds that can be achieved in the control chamber 5 of the injector according to the embodiments in FIGS. 1 and 2 can be used to exert influence on the injection into the combustion chamber of an internal combustion engine in such a way that the injection rate can be adapted to the progress of the combustion in the combustion chamber.

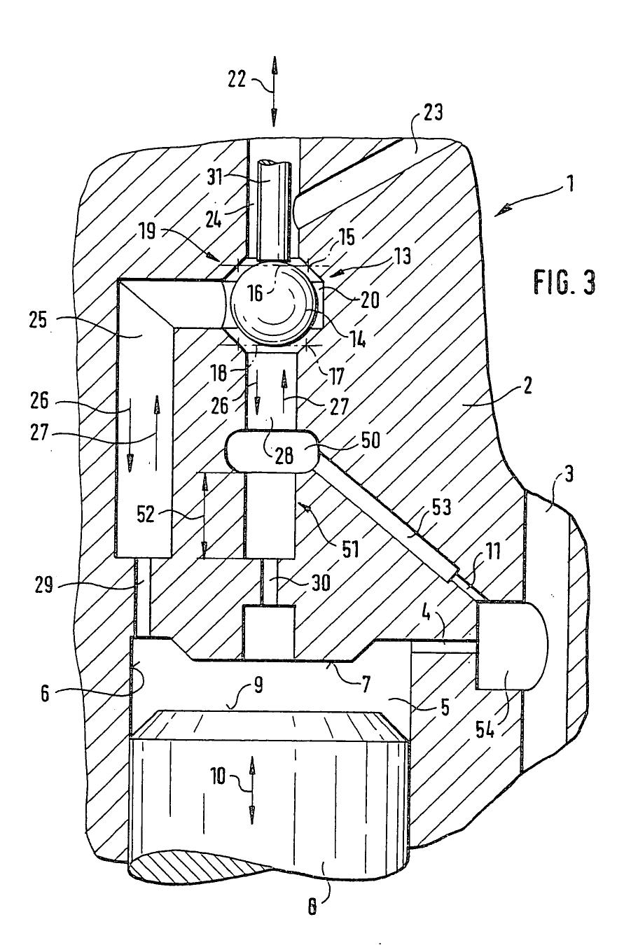

FIG. 3 shows an injector body whose control chamber is fed by an inlet conduit that feeds into one of the conduits connecting the control chamber to a valve chamber of the multi-way valve.

Analogous to the depiction of the embodiment in FIG. 2, the valve chamber 20 of a multi-way valve 13 and the control chamber 5, which acts on a nozzle needle/tappet device 8, are connected to each other via two conduits 25 and 28. The valve chamber 20 in the injector housing 2 contains a valve body 14; depending on how it is actuated by a piezoelectric actuator 22, a transmission element 31 places the valve body 14 into a first seat 15, a middle position 19, and a second seat 17.

The two conduits 25 and 28 between the valve chamber 20 of the multi-way valve 13 and the control chamber 5 inside the injector housing 2 permit fuel volumes and/or control volumes to flow both in the inlet direction 26 in relation to the control chamber 5 and in the outlet direction 27 in relation to the control chamber 5. Analogous to the embodiments according to FIGS. 1 and 2, the second conduit 28 feeds in underneath the second valve seat 17, which can be opened and closed by the preferably spherical valve body 14. Both the permanently active inlet throttle 4, which exerts pressure on the control chamber 5, and an additional inlet throttle 11 of an inlet conduit 23 branch off from an inlet chamber 24 embodied in the inlet 3 from the high-pressure accumulator. The inlet conduit 23 feeds into a region of an annular chamber 50, which is situated approximately in the middle of the second conduit 28, between the valve seat 15 and the additional throttle element 30. The section of the second conduit 28 that extends for a length 52 between the opening of the inlet conduit 52 and the additional throttle element 30 is embodied as a diffuser section 51. The length 52 of the diffuser section 51 is dimensioned so that the fuel flow can come into contact with the wall of the second conduit 28.

Because of the way in which the throttle cross sections of the throttle elements 29 and 30 in the first conduit 25 and second conduit 28 are designed, when the valve body 14 is opened by being moved out of its first valve seat 15, the control chamber 5 is discharged simultaneously via both of the throttle elements 29 and 30. If the valve body 14 of the multi-way valve 13, however, is moved into its second seat 17 in the valve chamber 20, then the second flow conduit 28 is closed and only the throttle element 29 of the first conduit 25, functioning as an outlet throttle, is operational. At the same time, the control chamber 5 is subjected to pressure in parallel by the permanently active first inlet throttle 4 and by the inlet conduit 53 that feeds into the closed closed second conduit 28 and contains an additional inlet throttle 11. In this case, the second throttle element 30 contained in the second conduit 28 functions as an inlet throttle in the reverse direction, i.e. in the inlet direction 26 toward the control chamber 5. However, if the actuator 22 is actuated and its transmission element 31 moves the valve body 14 of the multi-way valve 13 back into its first seat 15, then the outlet 23 is closed and the nozzle needle/tappet device 8 in the injector housing 2 closes very rapidly since the control chamber 5 is acted on by means of two inlet throttles 4 and 11, 53.

According to the embodiment shown in FIG. 3, a diffuser section 51 is provided between the additional throttle element 30 and the region 50 in which the inlet chamber 53 branching off from the inlet chamber 54 feeds into the second conduit 28. The length 52 of the diffuser section 51 is dimensioned so that the fuel flow can come into contact with the wall of the flow conduit 2, thus permitting a laminar flow to occur inside the second flow conduit 28.

The embodiment of the concept of the invention shown in FIG. 3 permits a fuel injector to be produced, which permits shaping of the discharge rate curve and whose nozzle needle/tappet device 8 can be moved into a closed position very rapidly. If the valve body 14 of the multi-way valve 13 closes the second valve seat 17, then depending on the design of the inlet throttle 11 provided in the inlet conduit 53, a minimal volume change in the control chamber 5 can be achieved so that by means of such a sensitive actuation of the nozzle needle/tappet device 8, even extremely small fuel injections can be executed during the boot phase of the injection. As a result, the control of a nozzle needle/tappet device 8 can be precisely adapted to the progress of the combustion in the combustion chamber of an internal combustion engine.

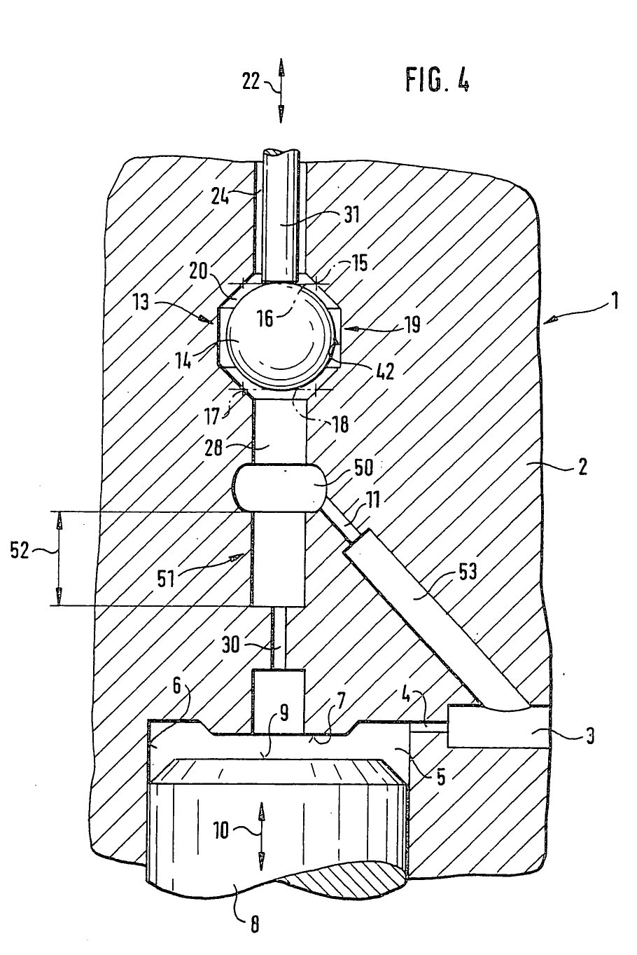

FIG. 4 shows another embodiment with only one flow conduit leading from the valve chamber to the control chamber, which conduit permits fuel to travel in both flow directions.

According to this embodiment, the valve chamber of the multi-way valve 13 and the control chamber 5 in the injector housing 2 are connected to each other by means of only one conduit 28. The nozzle chamber 5 in the injector housing 2 is continuously supplied with highly pressurized fuel via a permanent first inlet throttle 4 provided in the inlet from the high-pressure accumulator or from a differently configured high-pressure source. The control chamber 5 is delimited by a control chamber wall 6 and a control chamber surface 7. The nozzle needle/tappet device 8, which travels into and out of the nozzle chamber 5 in accordance with the double arrow 10, protrudes into the control chamber with its end surface 9.

The multi-way valve 13, whose valve body 14 is preferably embodied as spherical, can be moved in a vertical direction in the injector housing 2 by means of an actuator, not shown here, for example a piezoelectric actuator. It can be moved from a first valve seat 15 into a middle position 19 and into a second valve seat 17. The seat diameters between the curved outside of the valve body 14 and the seats in the injector housing 2 are depicted with dashed lines and are respectively labeled with the reference numerals 16 and 18. The valve chamber 20 encompasses the preferably spherically embodied valve body 14. The transmission element 31 that can be actuated by the actuator 22 is encompassed by an annular gap 24. The flow conduit 28 connecting the valve chamber 20 of the multi-way valve 13 and the control chamber 5 inside the injector housing 2 is provided with an annular expansion 50 into which an inlet conduit 53 feeds, which contains an additional inlet throttle 11. The annular chamber 50 provided in the flow conduit 28 is spaced apart at a distance 52 from the additional throttle 30 contained in the flow conduit 28. The length identified by the reference numeral 52 functions as a diffuser length of a diffuser 51, which extends between the annular expansion 50 of the flow conduit 28 and the additional throttle element 30 of the flow conduit 28. The inlet conduit 53 with the integrated additional inlet throttle element 11 is supplied by the high-pressure inlet 3, which likewise supplies highly pressurized fuel to the inlet throttle 4 permanently acting on the control chamber 5, thus assuring a sufficient pressure level in the control chamber 5 of the fuel injector.

If the piezoelectric actuator 22 is actuated and opens the multi-way valve 13 by moving it out of the first valve seat 15, then a pressure decrease occurs in the control chamber 5 as a result of a fuel volume flowing out via the valve chamber 20 and therefore the annular gap 24, into the low-pressure side of the fuel injector. The outflow is restricted by the outlet throttle 30 in the flow conduit 28. The flow is throttled by means of cavitation by the diffuser section 51 following this outlet throttle 30. If the valve body 14 of the multi-way valve, however, is switched into its second valve seat 17, then highly pressurized fuel acts on the control chamber in parallel via the permanently acting inlet throttle 4 and via the additional throttle element 11 in the inlet conduit 53. In this case, the additional throttle element 30 incorporated into the flow conduit 28 functions as a reverse-flow outlet throttle.

This embodiment makes it possible to design a double-switching injector, which achieves the rapid closing of the nozzle needle. This permits the injector to be designed in a very simple and compact manner. It is particularly advantageous that the permanent flow by means of the additional inlet throttle 11 in the open state results in an increased flow through the multi-way valve 13. This valve therefore also acts as a lag element so that the valve body 14 of the multi-way valve does not have to be switched rapidly, which permits the use of less expensive actuators 22.

1-10. (canceled)

11. A fuel injector for injecting fuel into the combustion chamber of an internal combustion engine, the injector comprising
an injector housing (2) containing a control chamber (5) acted on with highly pressurized fuel via a permanently acting inlet throttle (4) by means of an inlet (3) from a high-pressure accumulator;
a nozzle needle/tappet device (8) protruding into the control chamber (5), the needle/tappet device (8) being actuatable in a movement direction (10) by means of a pressure decrease or pressure increase in the control chamber (5), can be actuated in a movement direction (10), and
a multi-way valve (13) actuatable by an actuator to relieve pressure in the control chamber (5),
at least one conduit (25, 28) connecting a valve chamber (20) of the multi-way valve (13) and the control chamber (5) in the injector housing (2) to each other to permit a flow both in the inlet direction and in the outlet direction in relation to the control chamber (5), and one conduit (28) of said at least one conduit (25, 28) being closed by the multi-way valve (13) being placed in a second valve seat (17) and being open when a valve body (14) of the multi-way valve (13) is in a position (19) between a first valve seat (15) and the second valve seat (17).

12. The fuel injector according to claim 11, further comprising throttle elements (29, 30) are incorporated into at least one of the conduits (25, 28).

13. The fuel injector according to claim 11, wherein the at least one conduit (25, 28) permits a flow in the inlet direction (26) toward the control chamber (5) and a flow in the outlet direction (27) from the control chamber (5) to the valve chamber (20).

14. The fuel injector according to claim 12, wherein the at least one conduit (25, 28) permits a flow in the inlet direction (26) toward the control chamber (5) and a flow in the outlet direction (27) from the control chamber (5) to the valve chamber (20), and wherein the throttle elements (29, 30) in the at least one conduit (25, 28) act as inlet throttles in the inlet direction (26) and act as an outlet throttle element (29) or as parallel-connected outlet throttles (29, 30) in the outlet direction (27), depending on the switched position of the multi-way valve (13).

15. The fuel injector according to claim 11, further comprising an additional inlet (11) from the high-pressure accumulator feeding into the valve chamber (20) perpendicular to the operational direction of the valve body (14).

16. The fuel injector according to claim 11, further comprising an additional inlet (11) from the high-pressure accumulator feeding into one of the conduits (25, 28), above the respective throttle element (29, 30).

17. The fuel injector according to claim 16, wherein the additional inlet (11) feeds into the one of the two conduits (25, 28) that feeds into the valve chamber (20) next to the valve body (14) of the multi-way valve (13).

18. The fuel injector according to claim 11, further comprising an inlet conduit (53) branching off from the inlet (3) of the high-pressure accumulator and connected to the one of the conduits (25, 28) that can be opened or closed by the valve body (14).

19. The fuel injector according to claim 18, wherein the inlet conduit (53) feeds into an annular chamber (50) of the conduit (28), which annular chamber (50) is disposed spaced a distance (52) apart from the throttle element (30) contained in this conduit (28).

20. The fuel injector according to claim 19, wherein the space (52) between the opening of the inlet conduit (53) and the additional throttle element (30) is embodied with a length that places the fuel flow diverted from the control chamber (5) in contact with the wall of the section (51) of the second conduit (28).
